(19) United States
(12) Patent Application Publication
(10) Pub. No.: US 2009/0321186 A1
(43) Pub. Date: Dec. 31, 2009

(54) SWIVEL TREE STAND

(76) Inventor: Joel J. Louchart, Birch Run, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/490,889

(22) Filed: Jun. 24, 2009

Related U.S. Application Data
(60) Provisional application No. 61/076,237, filed on Jun. 27, 2008.

(51) Int. Cl. A01M 31/02

(52) U.S. Cl. 182/188

(57) ABSTRACT

A tree stand providing having a platform a superstructure pivotally secured to the platform and a series of support bearings interconnected by a first arm and a second consecutive arm. The second aim terminates in a seat, the bearings facilitating ease of repositioning and angle adjustability for left and right banded hunters seeking to aim at game on opposite sides.

### CROSS-REFERENCE TO RELATED APPLICATIONS

This application claims the benefit of U.S. Provisional Application 61/076,237 filed on Jun. 27, 2008.

### FIELD OF THE INVENTION

The present invention is directed to a tree stand design providing greater range of angle adjustability of a seat, this in part to compensate for aiming limitations associated with right handed and left handed hunters attempting to shoot at game from an opposite/blind side.

### BACKGROUND OF THE INVENTION

Tree stands are known in the art which include a seat pivotally secured to a vertical elevated locations, such as a tree trunk, telephone pole or the like. One example of a known swing arm tree stand is disclosed in U.S. Pat. No. 5,518,083, to Blennert, and which teaches a base held to a tree by chains or the like. An arm extends in side to side pivotal fashion in supported fashion between a pair of base secured lugs. A second arm can be pivotally supported at a distal end of the first aim, with a seat fastened to an end of the second arm.

Additional known tree stand devices include those disclosed in Woodall U.S. Pat. No. 5,848,666, which teaches a seat assembly pivotally attached to a vertically supported pole, and While U.S. Pat. No. 5,131,496, which discloses a tree seat incorporating a horizontal beam having a rotatable seat at one end and a vertical pin at the other end which is removably journalled in a complementary vertical element in turn secured to the tree by a pair of encircling straps.

### SUMMARY OF THE INVENTION

The present invention discloses a swivel adjustable tree stand which is an improvement over prior art swivel arm tree stands, such as in particular Blennert U.S. Pat. No. 5,518,083. The tree stand includes a floor platform from which extends a seat assembly exhibiting multiple (3) bearing supported pivot points (as opposed to the (2) bearing supported pivot points in Blennert) for providing a greater ease of repositioning such as for left and right handed hunters seeking to aim at game on opposite sides, and additionally provides a greater degree of structurally reinforcing user support in either of a standing or sitting position.

The bearings include a first bearing established between vertical secured supports of die stand and a first arm, a second bearing defining a pivot between the first arm and a second arm and a third bearing located at a distal end of the second arm and upon which is further rotatably supported a seat. The bearings as constructed provide ranges of rotation ranging, varying between 180° to 360°, each of the bearings further exhibiting heavy-duty load bearing components which capably support the weight of the user, during respective pivotal displacement, and when engaged at an elevated location to such as a tree or pole.

Additional features include the incorporation of threaded tightening bolts for optionally securing the second and third bearings in a given multi-axis rotated position. A spring loaded pin extends vertically between a pair of spaced apart flanges associated with the first bearing and includes an upper hooked end seating through the upper flange at first and second locations. Upon rotating the first arm in a given direction, a tab projecting from a surface of the first bearing is captured within the hooked portion of the pin to selectively prevent rotation of the first bearing.

Support feet associated with the stand can include adjustable feet which are screw adjustable or which can traverse along a hole and pin system. Exterior engaging surfaces associated with the feet can include elongated teeth, spike portions or other frictional engaging portions for establishing a more secure engagement to the tree/utility pole or the like and to render more level the standing platform.

The floor platform is secured to bottom locations of a pair of vertically extending supports with additional tension support cables extending from intermediate perimeter extending locations of the platform to upper ends of the vertical supports. The floor platform is dimensioned to provide either sitting or standing support to the user. An angularly adjustable support brace is pivotally secured both at a lower end at a location shouldered by the vertical supports and at au upper location to an underside of the first arm.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 an environmental perspective view of the tree stand according to the present invention;

FIG. 2 is a rotated rear perspective view of the tree stand in FIG. 1 and further showing the configuration of the upper and lower rear supports, as well as the width and height dimensions of the seat and platform;

FIG. 3 is a side plan view of the tree stand as shown in FIG. 1 and in which the support alms and seat are illustrated in a maximum extended position;

FIG. 4 is a further side plan view illustrating the support arms and seat in a retracted position;

FIG. 5 is an illustration similar to FIG. 1 and further illustrating the angularly adjustable support brace at a further reposition corresponding to pivoting of the first arm;

FIG. 6 is a collapsed and transportable/storable perspective of the tree stand;

FIG. 7 is an enlarged partial perspective of the spring loaded pin extending vertically between a pair of spaced apart flanges associated with the first bearing and including an upper hooked end seating through the upper flange at first and second locations such that, upon rotating the first arm in a given direction, a tab projecting from a surface of the first bearing is captured within the hooked portion of the pin to selectively prevent rotation of the first bearing; and

FIG. 8 is a further enlarged partial perspective of the angularly adjustable support brace and lower support feet.

### DETAILED DESCRIPTION OF THE PREFERRED EMBODIMENTS

As will be described in detail upon examination of the below referenced illustrations, the present invention discloses a tree stand design providing greater range of angle adjustability of a seat, this in part to compensate for aiming limitations associated with right handed and left handed hunters attempting to shoot at game from an opposite/blind side.

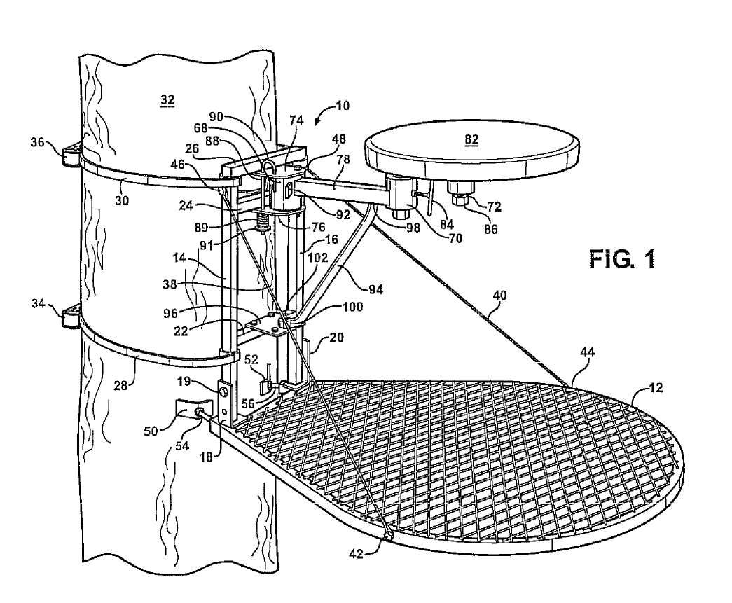

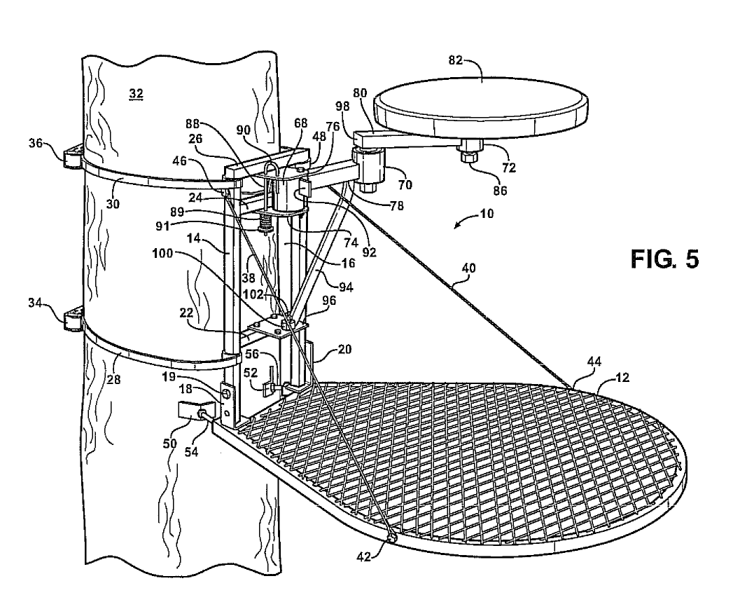

Referring now to each of FIGS. 1-8, a series of perspective, plan and partial views are shown of tree stand 10 according to the present invention. The tree stand includes a floor platform 12, such as exhibiting a oval/ellipsoidal or other desired shape and optionally including a grated and brace supported surface.

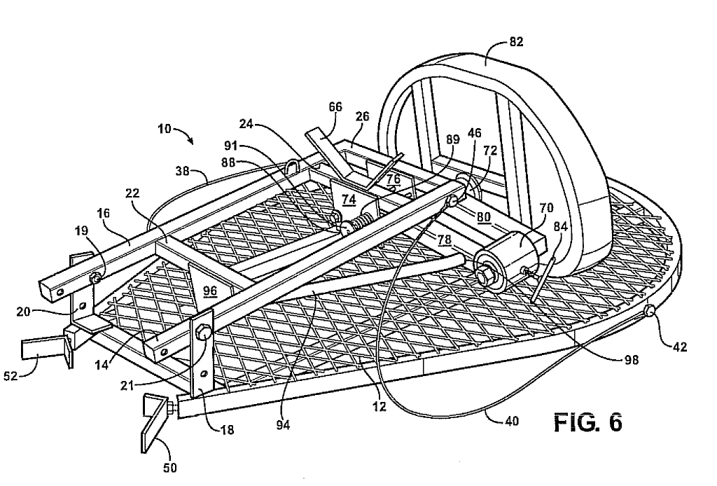

A pair of spaced apart and primary/upwardly extending, typically tubular, supports 14 and 16 extend upwardly from rear edge locations of the platform 12, as further illustrated by rear angled brackets 18 and 20. The tubular supports 14 and 16 are pivotally attached to the platform supported brackets 18 and 20 at locations 19 and 21, these corresponding to apertures aligning with the brackets 18 and 20 and tubular supports 14 and 16, through which are installed pins or fasteners which are selectively tighten-able to establish an unfolded use position (FIG. 1) and loosened, such as upon removal of the assembly, to permit folding of the superstructure defining supports 14 and 16 against the platform 12 (FIG. 6).

Crosswise extending supports 22, 24 and 26 extend between the tubular supports 14 and 16 at specified locations. Straps 28 and 30 connect to locations associated with the tubular supports 14 and 16 and encircle a vertically extending support surface 32, such as a tree or utility pole, and in order to anchor the superstructure at a desired elevated location. The straps 28 and 30 typically include ratchet or cinch portions, at 34 and 36, in order to tighten the straps for firmly engaging the stand to the tree or like vertical support.

A pair of support cables, at 38 and 40, extend between lateral lowermost locations, at 42 and 44, associated with the platform 12 to upper most end locations, at 46 and 48, associated with the primary supports 14 and 16. The support cables 38 and 40 are flexible to permit the stand to be converted between the folded position of FIG. 6 and the extended use positions of FIGS. 1-5, and such that the platform 12 is suspended in a generally 90° angle relative to the superstructure (again collectively defined as including vertical supports 14 and 16 and crosswise supports 22, 24 and 26). Although not shown, sub-variants of the tree stand can include lower positioned latches, such as established at hinged locations, and in order to restrain the platform in a selected angular position relative to the superstructure. The use of latching mechanisms can also be dispensed with in the instance of the cables 42 and 44 providing tensioning and suspending support to the platform 12.

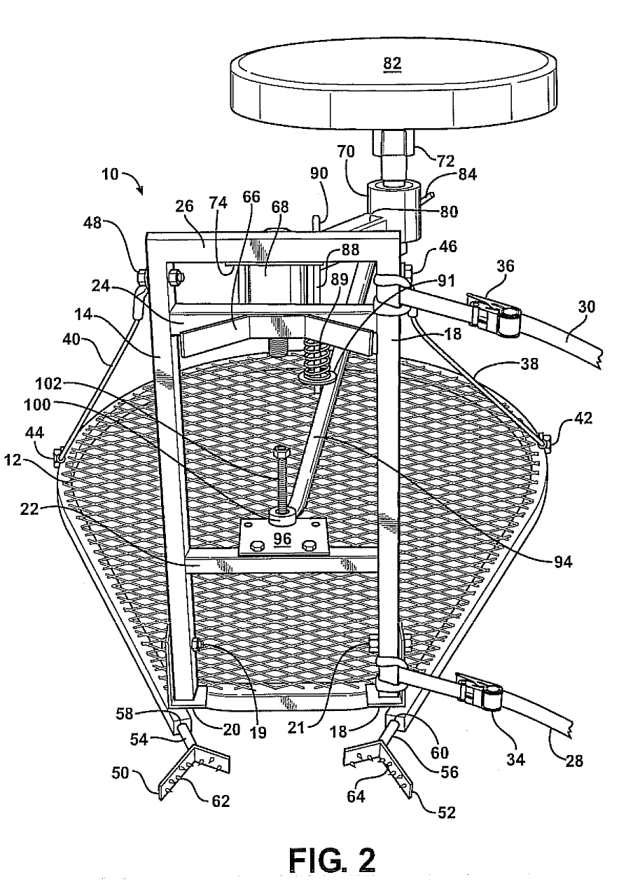

Lower situated feet are shown at 50 and 52, these typically angled to better contact the arcuate surface of the vertical support 32, the feet typically including a threaded shaft or stem portion, at 54 and 56, which is typically screw threaded or adjustable with rear aperture mounting locations 58 and 60 (see as best shown in FIG. 2) associated with rear facing ends of a perimeter extending support associated with the platform 12. Although not shown, the threaded adjustable lower support feet can also be substituted with a hole and pin system defined in a modified foot support shaft which allows the stem portion of each foot support to be linearly readjusted relative to receiving channels defined in rear facing locations.

The feet are further capable of including elongated teeth or spike portions, or other frictional enhancing surfacing (see at 62 and 64 in FIG. 2) for establishing a more secure engagement to the vertically extending support 32 (e.g. tree trunk or pole) and to render more level the platform 12 for standing or other support to a user. An upper angled bracket 66 (see as best shown in FIGS. 2 and 6) is fixedly secured to a rear surface of the generally upper structural end located crosswise support 24 and likewise engages an arcuate location of the vertical support 32 upwardly spaced from the lower support feet 50 and 52.

The swiveling aspects of the tree stand incorporate three consecutive support bearing supports these including, in addition to first rotatable bearing 68, a second rotatable bearing 70 and a third rotatable bearing 72.

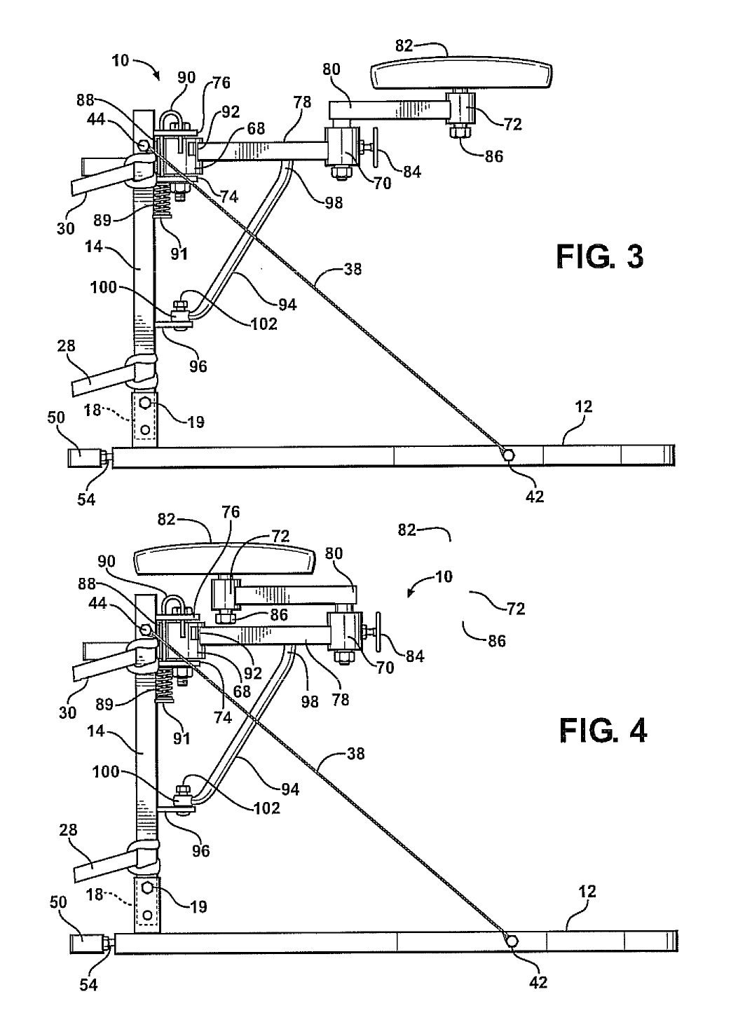

The first bearing 68 is established between the vertical secured supports 14 and 16 of the stand, via a pair of upper 74 and lower flanges 76 extending respectively from the upper crosswise extending supports 24 and 26 in order to define a first pivot point. A first (generally tubular cross sectional shaped) arm 78 extends between the first bearing 68 and second bearing 70, which further defines a second pivot between the first aim 78 and a second arm 80 (FIGS. 3 and 4). A third bearing 72 is located at a distal end of the second arm 80 and upon which is farther rotatably supported a seat 82.

The bearings as constructed provide ranges of rotation ranging, varying between 180° to 360°, each of the bearings farther exhibiting heavy-duty load bearing components which capably support the weight of the user, during respective pivotal displacement, and when engaged at all elevated location to such as a tree or pole. The advantage of multiple (3) bearing supported pivot points facilitates ease of repositioning of the seat 82, such as for compensating left and right handed hunters seeking to aim at game on opposite sides. Additional features can include the incorporation of threaded locking fasteners, see as shown in FIG. 1 by threaded locking fastener 84 associated with second bearing 70 and locking nut fastener 86 for third (seat underside) bearing 72 for optionally fixedly positioning the seat 82 in place following a desired multi-axial rotated positioning.

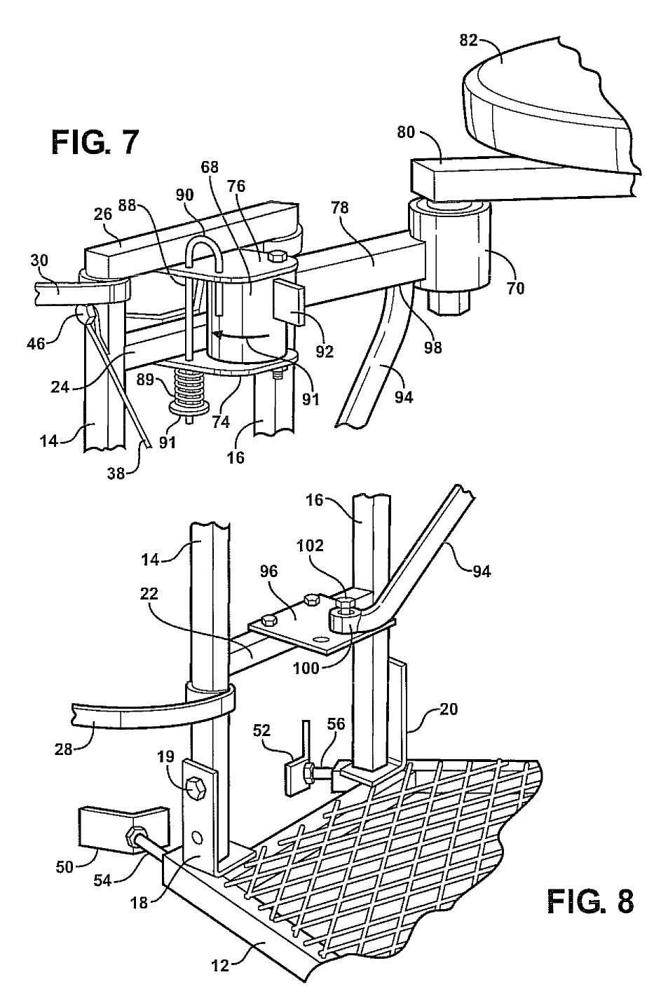

A spring loaded pin 88 extends vertically between the pair of spaced apart flanges 74 and 76 associated with the first bearing 68 and includes an upper hooked end 90 seating through the upper flange 74 at first and second locations (see as best shown in FIG. 7). See also underside positioned coil spring 89 between lower support flange 74 and a fixed end supported washer 91 associated with a lower end of the pin 88. Upon rotating the first arm 78 in a given direction (see arrow 91 in FIG. 7), a tab 92 projecting from a surface of the first bearing 68 is captured within the hooked portion 90 of the pin 88 to selectively prevent rotation of the first bearing 68, and thereby the first arm 78.

An angularly adjustable support brace 94 is pivotally secured at a lower location to a bracket 96 supported upon the crosswise support 22, and at an upper end to a forward intermediate underside location 98 of the first arm 78. As best shown in FIG. 8, the lower end of the brace 94 farther exhibits a collar 100 which is rotatably supported by a support pin 102 and which, in combination with the pivotal aspect of the first arm 78 via first bearing 68, enables the support brace 94 to rotate along with the first arm 78 about a first predetermined pivotal range and so that the assembly provides an enhanced degree of load bearing support to the user when applying downward force upon the seat 82.

Having described my invention, other and additional preferred embodiments will become apparent to those skilled in the art to which it pertains, and without deviating from the scope of the appended claims. Although not shown, these can include such fold-out side platforms pivotally secured along opposite edges of the main standing platform 12 and which can be provided with edge extending support hinges in order to selectively increase a standing area associated with the tree stand.

I claim:

1. A tree stand, comprising:
a platform;
a superstructure pivotally secured to said platform and adapted to being secured to a vertically extending supporting surface; and
a series of first, second and third support bearings interconnected by a first arm and a second consecutive arm, said second arm terminating in a seat, said bearings facilitating ease of repositioning such as for left and right handed hunters seeking to aim at game on opposite sides.

2. The tree stand as described in claim 1, each of said first, second and third rotatably supporting bearings providing a range of rotation ranging varying between 180° C. to 360°, each of said bearings further exhibiting heavy-duty load bearing components which capably support the weight of a user, during respective pivotal displacement, and when engaged at an elevated location to such as a tree or pole.

3. The tree stand as described in claim 1, further comprising treaded locking fasteners for preventing rotation of said second and third bearings.

4. The tree stand as described in claim 1, further comprising support feet secured to rear end locations of said platform.

5. The tree stand as described in claim 4, said support feet being adjustable relative to said platform, and which may incorporate including elongated teeth or spike portions for establishing a more secure engagement to the tree and to render more level the standing platform.

6. The tree stand as described in claim 1, further comprising support cables suspending said platform from said superstructure in a substantially 90° arrangement.

7. The tree stand as described in claim 1, farther comprising an angled support brace rotatably secured at a lower location to a bracket associated with said superstructure and at an upper end to a forward intermediate underside location of said first arm.

8. The tree stand as described in claim 7, a lower end of said angled brace further comprising a collar which is rotatably supported by a support pin.

9. The tree stand as described in claim 4, further comprising an angled bracket fixedly secured to a rear surface of said superstructure in upwardly spaced from said support feet.

10. The tree stand as described in claim 1, further comprising a spring loaded pin extending vertically between a pair of spaced apart flanges associated with said first bearing, said pin including an upper hooked end seating through said upper flange at first and second locations.

11. The tree stand as described in claim 10, further comprising an underside positioned coil spring located between said lower support flange and a fixed end supported washer associated with a lower end of said pin such that, upon rotating said first arm in a given direction, a tab projecting from a surface of said first bearing being captured within said hooked portion of said pin to selectively prevent rotation of said first bearing, and thereby said first arm.

12. The tree stand as described in claim 6, further comprising first and second support brackets secured upon rear locations of said platform and to which said superstructure is pivotally secured.

13. The tree stand as described in claim 1, further comprising straps connect to locations associated with said superstructure and encircling the vertically extending support surface in order to anchor the superstructure at a desired elevated location, said straps including ratchet portions for tightening said straps to fly engaged to the support surface.

14. A tree stand comprising:
a superstructure secured to a vertically extending supporting surface and including first and second vertically extending supports between which extend a plurality of crosswise supports;
a platform pivotally secured to a lower end said superstructure;
a pair of flexible support cables extending between locations associated with said platform to elevated locations associated with said vertically extending supports; and
a series of bearings interconnected by a first arm and a second arm, said second arm terminating in a seat, said bearings facilitating ease of repositioning such as for left and right handed hunters seeking to aim at game on opposite sides.

15. The tree stand as described in claim 14, said bearings further comprising a first bearing established between said vertically extending supports via a pair of upper and lower flanges extending respectively from a pair of upper crosswise extending supports selected from said plurality of crosswise supports and in order to define a first pivot point.

16. The tree stand as described in claim 15, further comprising a spring loaded pin extending vertically between said pair of spaced apart flanges associated with said first bearing, said pin including an upper hooked end seating through said upper flange at first and second locations.

17. The tree stand as described in claim 16, further comprising an underside positioned coil spring located between said lower support flange and a fixed end supported washer associated with a lower end of said pin such that, upon rotating said first arm in a given direction, a tab projecting from a surface of said first bearing being captured within said hooked portion of said pin to selectively prevent rotation of said first bearing, and thereby said first arm.

18. The tree stand as described in claim 15, further comprising said first arm extending from said first bearing and terminating in a second bearing, a second arm extending from said second bearing and terminating in a third bearing located at an underside of said seat.

19. The tree stand as described in claim 14, farther comprising support feet secured to rear end locations of said platform and being adjustable relative to said platform.

20. The tree stand as described in claim 14, further comprising an angled support brace rotatably secured at a lower location to a lower bracket selected from said plurality of crosswise extending brackets, said support brace being secured at an upper end to a forward intermediate underside location of said first arm.
